(19) United States
(12) Patent Application Publication
(10) Pub. No.: US 2008/0184689 A1
(43) Pub. Date: Aug. 7, 2008

(54) HARVESTING HEADER REEL MOUNTING APPARATUS

(75) Inventor: RANDY LOHRENTZ, BUHLER, KS (US)

Correspondence Address: HOVEY WILLIAMS LLP, 10801 Mastin Blvd., Suite 1000, Overland Park, KS, 66210, US

(73) Assignee: AGCO CORPORATION, Duluth, GA (US)

(21) Appl. No.: 11/671,930

(22) Filed: Feb. 6, 2007

(51) Int. Cl. A01D 57/02; A01D 69/03

(52) U.S. Cl. 56/11.9; 56/222

(57) ABSTRACT

The reel of a harvesting machine is rotatably supported at its opposite ends by a pair of fore-and-aft extending arms. Carrier assemblies adjustably couple the reel with the arms such that the reel may be adjustably positioned in fore-and-aft directions along the arms. The reel drive at one end of the reel is totally supported by the carrier assembly at that end of the reel such that all parts of the drive remain in aligned operating relationship with one another regardless of the fore-and-aft position of the reel or any unintended skewing thereof.

### TECHNICAL FIELD

The present invention relates to harvesting headers of the type utilizing large, rotating reels to help sweep the standing crop materials into cutters across the front of the header for improved cutoff and, more particularly, to improvements in the way such reels are mounted on the header to avoid misalignment problems between operating components of the drive mechanism coupled with the reel.

### BRIEF DESCRIPTION OF THE DRAWINGS

FIG. 1 is a fragmentary front isometric view of a harvesting header constructed in accordance with the principles of the present invention and utilizing a bat-type reel;

FIG. 2 is a right side elevational view thereof with certain shielding removed to reveal details of construction;

FIG. 3 is a right side elevational view similar to FIG. 2 but with the drive chain and large sprocket removed to reveal details of construction;

FIG. 4 is a fragmentary top plan view of the drive end of the header with the reel removed to reveal details of construction;

FIG. 5 is a front elevational view of the drive end of the header revealing details of construction;

FIG. 6 is an exploded isometric view of the drive end of the header illustrating components at that location;

FIG. 7 is a right rear isometric view of the carrier assembly at the drive end of the header;

FIG. 8 is a left front isometric view of the carrier assembly;

FIG. 9 is a right side elevational view of an alternative embodiment of carrier assembly at the drive end of the header especially adapted for supporting a retracting finger-type reel having an axis of rotation at a different location than the bat-type reel of FIGS. 1-8;

FIG. 10 is a left front, fragmentary isometric view of the drive end of the reel of the embodiment of FIG. 9; and

FIG. 11 is an isometric view of a reel support bracket forming a part of the carrier assembly of the embodiment of FIG. 9.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

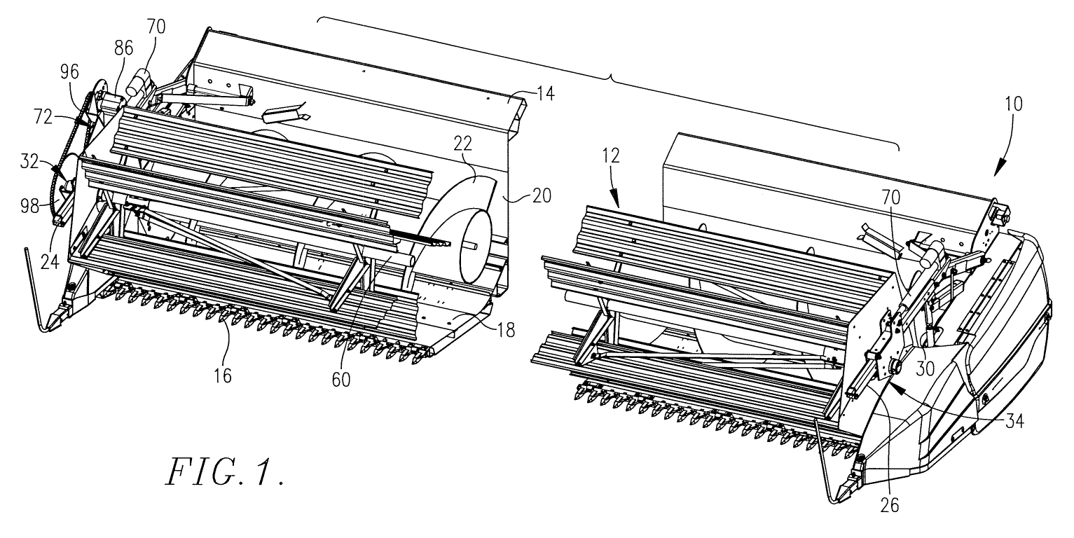

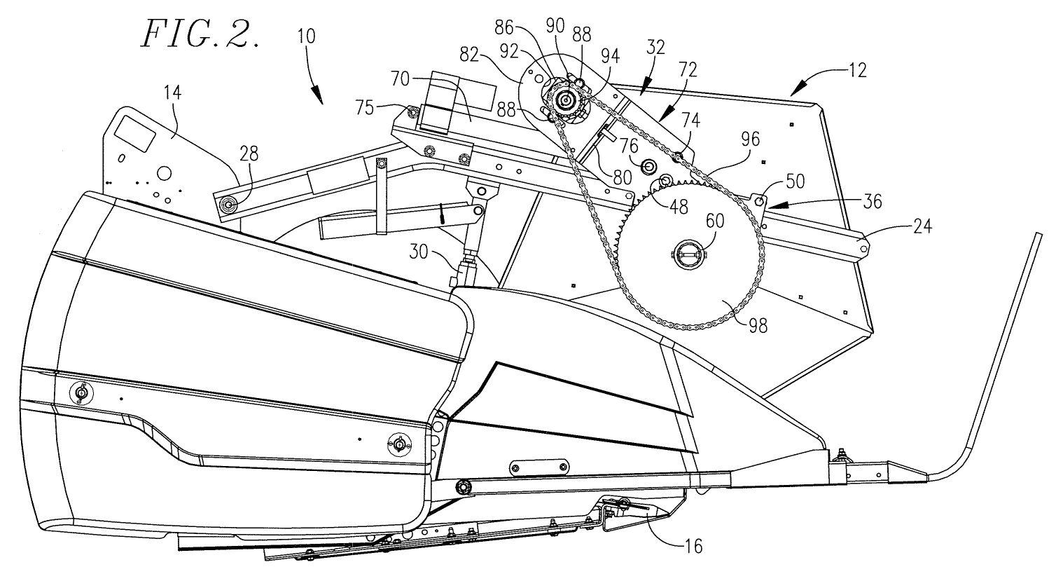

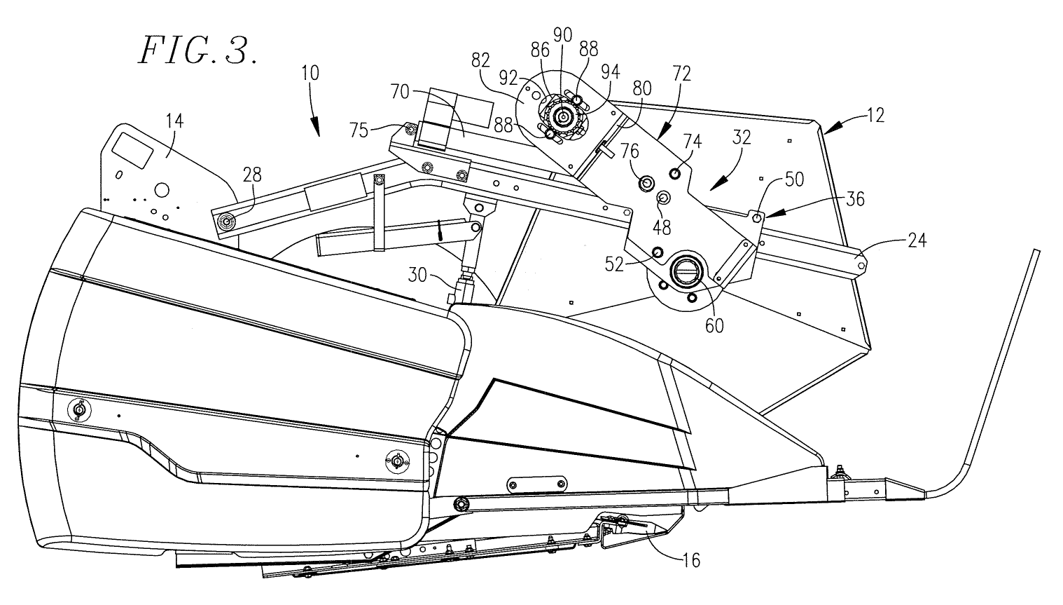

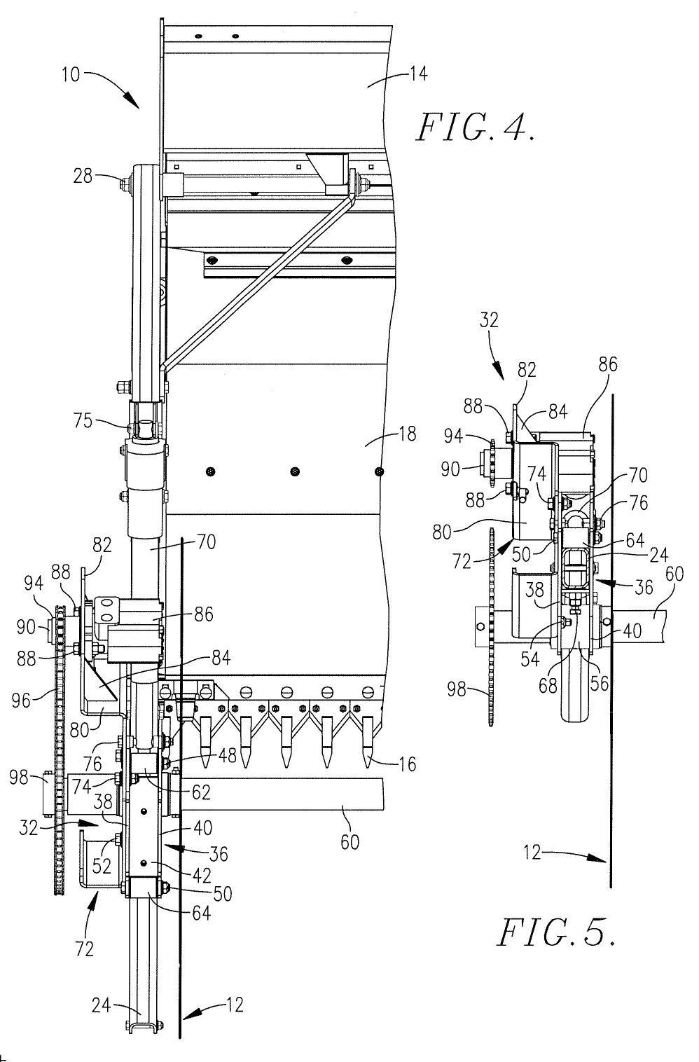

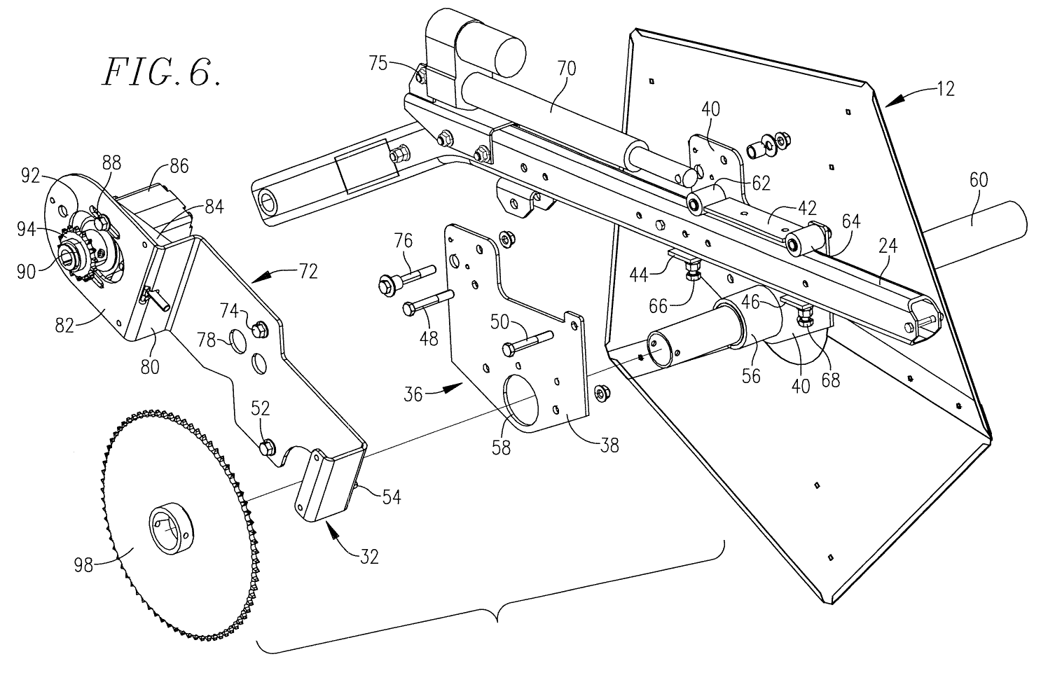

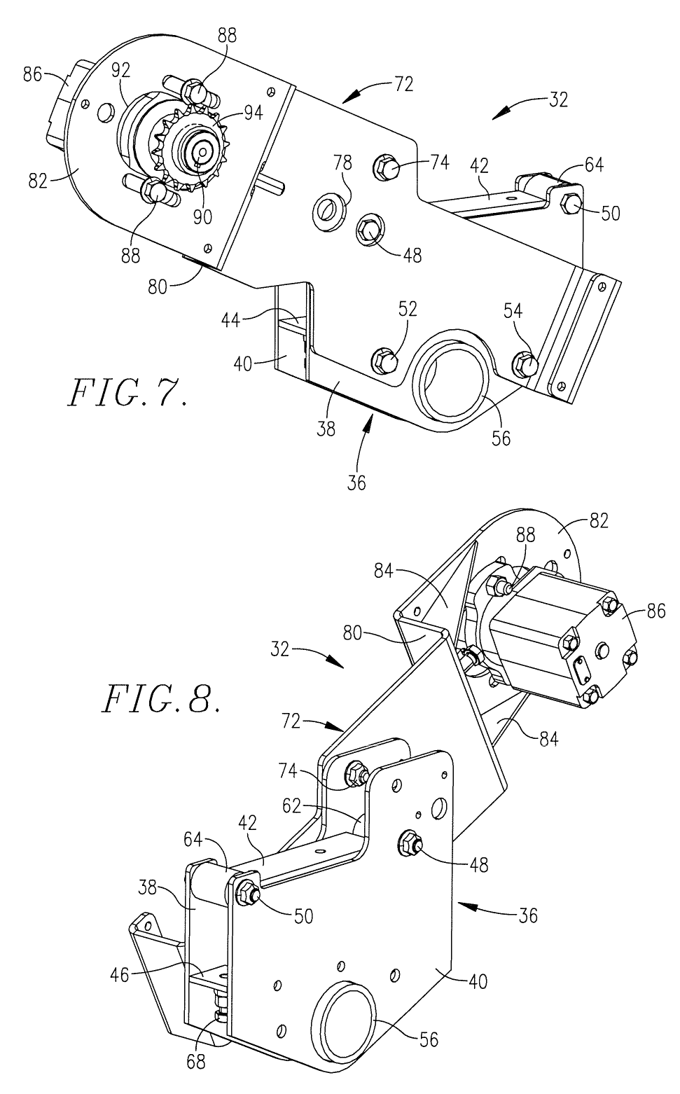

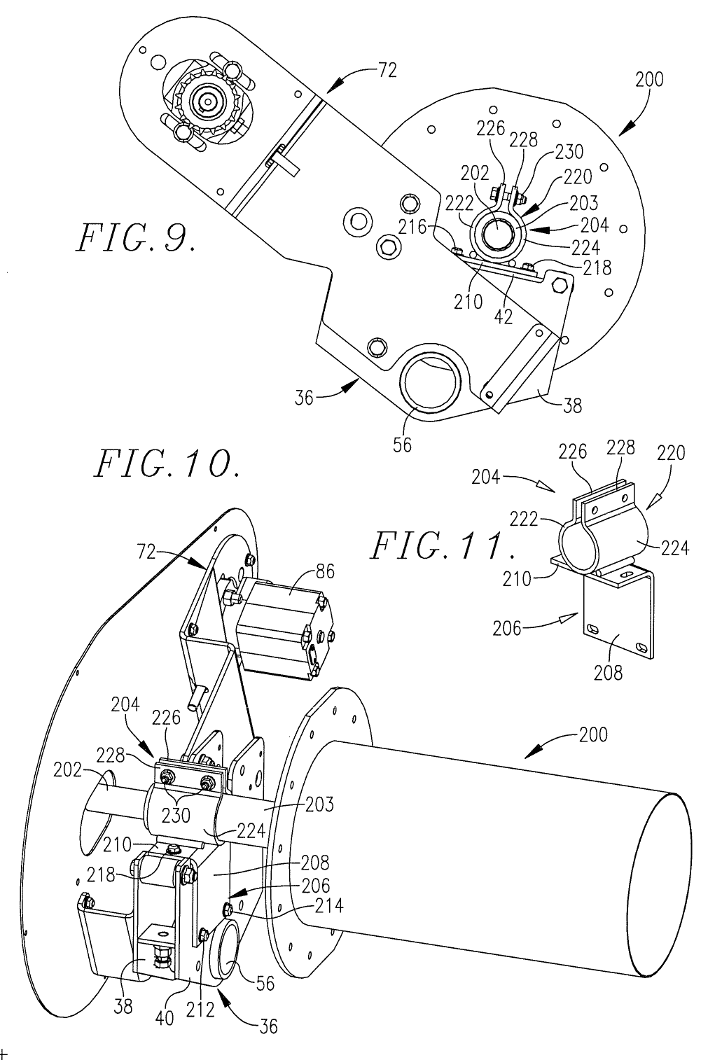

The exemplary harvesting header 10 of FIGS. 1-8 is shown as having a bat-type reel 12. However, as will be apparent, such illustration is for purposes of example only, as the principles of the present invention are not limited to any particular type of reel. Indeed, as hereinafter described, the reel in the alternative embodiment of FIGS. 9-11 is a folding finger-type reel.

Among other things, as well understood by those skilled in the art, header 10 includes a frame 14 supporting suitable cut-off means such as a reciprocating sickle assembly 16 across the lower front of the header. A pan or floor 18 extends rearwardly from sickle assembly 16 to a generally upright rear wall 20, and a center-gathering auger 22 located above floor 18 and forwardly of rear wall 20 conveys severed crop material toward the center of header 10 for discharge into the feederhouse (not shown) of a harvesting machine to which the header is normally attached.

Reel 12 is supported above floor 18 and in front of auger 22 by a pair of elongated, fore-and-aft extending, laterally spaced apart arms 24 and 26 adjacent opposite ends of header 10. As is well known in the art, arms 24, 26 are pivotally mounted at their rear ends to frame 14 at pivots 28 to enable reel 12 to be adjustably raised and lowered relative to floor 18 and sickle assembly 16. Hydraulic cylinders 30 interconnect arms 24, 26 with frame 14 for effecting powered raising and lowering of arms 24, 26 to adjust reel height.

A pair of carrier assemblies 32 and 34 are provided on arms 24 and 26 respectively for mounting opposite ends of reel 12 on arms 24, 26 in a rotatable manner and for allowing reel 12 to be adjustably positioned fore-and-aft along arms 24, 26. Carrier assemblies 32 and 34 are similar in many respects, although in the disclosed embodiment the right carrier assembly 32 is adapted to support the drive for reel 12 while carrier assembly 34 has no such drive. It is within the principles of the present invention, however, to have both carrier assemblies 32, 34 provided with drives for reel 12, or for the drive to be associated with carrier assembly 34 instead of carrier assembly 32.

Each carrier assembly 32, 34 includes a box-like carrier 36 having a pair of laterally spaced apart, opposite side plates 38, 40, a top plate 42 fixed to and extending between side plates 38, 40, and a pair of shorter transverse plates 44, 46 spaced below top plate 42 and fixed to side plates 38, 40. A pair of bolts 48 and 50 at opposite ends of top plate 42 rotatably support a pair of transverse anti-friction rollers 62 and 64 respectively. A transversely extending, cylindrical bushing 56 adjacent the bottom of carrier 36 is fixed as by welding to side plates 38, 40 and projects through carrier 36 for the purpose of rotatably receiving a tubular driven shaft 60 of reel 12. Thus, the shaft 60 of reel 12 is rotatably received at its opposite ends by the two carrier assemblies 32 and 34.

Each arm 24, 26 is received by its corresponding carrier assembly 32 or 34 between the rollers 62, 64 at the top and the short plates 44, 46 at the bottom. Thus, the carrier assemblies 32 and 34 are guided for fore-and-aft adjusting movement along arms 24, 26 as rollers 62, 64 ride along the top edges of the arms 24, 26. A pair of set screws 66, 68 are supported by short plates 44, 46 for allowing the operator to manually lock the carrier assemblies 32, 34 in selected positions along arms, 24, 26, if desired.

Each arm 24, 26 has a linear actuator 70 along the top edge thereof that is attached at one end to the arm by a pivot bolt 75 and at the other end to carrier 36 by a pivot bolt 76 for providing the desired remote actuation of carrier assemblies 32, 34 along arms 24, 26. In a preferred embodiment, the linear actuators 70 are electrically powered, but as will be apparent to one skilled in the art, many other types of such actuators could be utilized. In a preferred form, actuators 70 are operated remotely by suitable means located in the cab of the harvesting machine (not shown).

As noted above, carrier assembly 32 differs from carrier assembly 34 in that assembly 32 also supports a drive assembly for reel 12. To this end, carrier assembly 32 also includes a large, generally Z-shaped mounting bracket 72 that is rigidly affixed to carrier 36 and extends upwardly and rearward therefrom at an angle. Bracket 72 is affixed to outboard side plate 38 by three bolts 52, 54, and 74 on opposite fore-and-aft sides of bushing 56. A clearance opening 78 in bracket 72 is aligned with the head of bolt 76 and allows the same to project outwardly partially through bracket 72 for access purposes.

Mounting bracket 72 has an outward joggle 80 adjacent its upper end leading to a fore-and-aft extending motor mounting portion 82. Gussets 84 interconnect mounting portion 82 with joggle 80 to stabilize mounting portion 82. A motor 86, preferably of the rotary hydraulic type, is mounted on the inboard side of bracket portion 82 by mounting bolts 88 and has an output shaft 90 that projects through an elongated opening 92 in mounting portion 82. Pressurized hydraulic fluid is supplied to motor 86 by a suitable source, not shown. As will be seen, the elongated nature of opening 92 and the corresponding elongation of openings within which bolts 88 are disposed allows the position of motor 86 to be adjusted in a fore-and-aft sense.

A drive sprocket 94 is fixed to output shaft 90 for rotation therewith and is entrained by an endless drive chain 96. Drive chain 96 is also entrained around a large driven sprocket 98 that is fixed to the outwardly projecting end of driven shaft 60 associated with reel 12. Thus, motor 86 provides driving power for reel 12 via output shaft 90, drive sprocket 94, chain 96 and driven sprocket 98.

It will be appreciated that hydraulic motor 86 and driven shaft 60 of reel 12 are supported by one and the same structure, i.e., the carrier assembly 32. Thus, when reel shaft 60 is moved along arm 24 by linear actuators 70, motor 86 moves with it at all times. Even if reel shaft 60 should become slightly skewed relative to the front edge of the header 10 due to problems with linear actuators 70, carrier assembly 36 and motor 86 maintain their constant relationship with reel shaft 60 and the rest of the reel. Likewise, if the left and right lift cylinders 30 should happen to get out of phase with respect to one another for any reason, resulting in cocking of the reel 12, the relationship between carrier assembly 36 and motor 86 remains unaffected. Thus, driven sprocket 98 and drive sprocket 94 always remain in the same plane with respect to one another so as to avoid any tendency for drive chain 96 to break or fall off the two sprockets. By avoiding misalignment between sprockets 94 and 98 at all times, regardless of any skewing of the reel 12 that might occur, the operator can be assured that drive chain 96 remains entrained around sprockets 94, 98 and in constant driving engagement therewith.

### Alternative Embodiment

FIGS. 9-11 show an alternative embodiment that is especially adapted for a folding finger-type reel as opposed to the bat-type reel of FIGS. 1-8. Although certain details of construction are different, it will be seen that the drive motor in this embodiment remains in constant relationship with the reel in the same manner as the embodiment of FIGS. 1-8.

In the embodiment of FIGS. 9-11, the reel 200 has its tubular shaft 202 rotatably received by a stationary tube 203 that is, in turn, supported by a special support bracket 204 mounted on top of carrier 36, rather than having shaft 202 receiving by bushing 56 near the bottom of carrier 36. Motor 86 remains supported on carrier assembly 32 via mounting bracket 72 in the same manner as in the embodiment of FIGS. 1-8 and thus moves with carrier assembly 32 and reel shaft 202 during all movements of those structures.

As illustrated particularly in FIG. 11, support bracket 204 includes an inverted, generally L-shaped member 206 having an upright leg 208 and a top, horizontal leg 210. Upright leg 208 is secured to the inboard side of carrier side plate 40 by a pair of fastening bolts 212 and 214. The top horizontal leg 210 is secured to spacer plate 42 by a pair of fastening bolts 216 and 218.

Support bracket 204 further includes a generally cylindrical clamp 220 that is fixed to top leg 210 such as by welding and is disposed transversely of the longitudinal axis of carrier 36. Clamp 220 has a pair of opposed, generally semi-circular arms 222 and 224 that embrace tube 203. At their upper ends, arms 222 and 224 are provided with opposing flat faces 226 and 228 that are interconnected by a pair of bolts. When the bolts 230 are tightened, arms 220, 224 can flex toward one another by an adequate amount to firmly clamp and hold tube 203 in place on carrier 36 against rotation. Thus, reel 200, shaft 202, carrier assembly 32 and motor 86 all move as a unit during any adjustment of reel 200 and unintended skewing thereof.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. In a harvesting header, the improvement comprising:
a pair of elongated, laterally spaced apart, fore-and-aft projecting support arms;
a pair of carrier assemblies shiftably mounted on said arms for fore-and-aft adjusting movement along the arms;
a reel rotatably supported at opposite ends thereof by said carrier assemblies whereby to render the reel adjustable in a fore-and-aft direction relative to the arms; and
a drive assembly mounted on at least one of said carrier assemblies and operably coupled with the reel for rotating the same in all positions of said fore-and-aft adjustment of the reel.

2. In a harvesting header as claimed in claim 1,
said reel including a driven shaft,
said drive assembly including a first sprocket secured to said driven shaft, a motor secured to said carrier and having a rotatable drive shaft, a second sprocket secured to said drive shaft, and a chain operably interconnecting said first and second sprockets.

3. In a harvesting header as claimed in claim 1,
said reel including a driven shaft,
said one carrier assembly including a carrier rotatably supporting said driven shaft,
said one carrier assembly further including a bracket fixed to said carrier,
said drive assembly including a motor mounted on said bracket and operably coupled with said driven shaft for driving the reel.

4. In a harvesting header as claimed in claim 3,
said motor having an output shaft,
said drive assembly further including a driven sprocket fixed to said driven shaft, a drive sprocket fixed to said output shaft, and a chain entrained around said drive sprocket and said driven sprocket.

5. In a harvesting header as claimed in claim 3,
said motor comprising a hydraulic motor.

6. In a harvesting header as claimed in claim 1,
each of said carrier assemblies including a carrier having a first bearing support for rotatably receiving a shaft of a first reel of the header,
said carrier further including a second bearing support for rotatably receiving a shaft of an alternative reel of the header when the first reel is not used.
